(19) United States
(12) Patent Application Publication
(10) Pub. No.: US 2013/0102500 A1
(43) Pub. Date: Apr. 25, 2013

(54) Microarray Comprising Immobilisation Particles

(71) Applicants: Michael Stumber, Korntal-Muenchingen (DE); Martina Daub, Weissach (DE); Jochen Rupp, Stuttgart (DE)

(72) Inventors: Michael Stumber, Korntal-Muenchingen (DE); Martina Daub, Weissach (DE); Jochen Rupp, Stuttgart (DE)

(73) Assignee: Robert Bosch GmbH, Stuttgart (DE)

(21) Appl. No.: 13/635,148

(22) PCT Filed: Jan. 20, 2011
(86) PCT No.: PCT/EP2011/050763

§ 371 Date: Nov. 27, 2012

(30) Foreign Application Priority Data
Mar. 17, 2010 (DE) 10 2010 002 957.2

(51) Int. Cl. B01J 19/00

(52) U.S. Cl. CPC B01J 19/0046
USPC 506/13; 506/40; 506/32

(57) ABSTRACT

A microarray comprises a carrier substrate and a plurality of immobilization particles configured to immobilize capture molecules. Each immobilization particle comprises a first sub-section bonded to the carrier substrate and a second sub-section which is exposed.

The present invention relates to a microarray, to a device for producing a microarray of this type, to a method for producing a microarray of this type, and to the use thereof.

### PRIOR ART

Microarrays are bioanalytical tools for identifying and quantifying from complex mixtures individual molecular groups by virtue of specific key-lock bonds at precisely defined points (spots) on a carrier substrate. Microarrays are used for the identification and quantification of nucleic acids, proteins, cells and small molecules.

Microarrays are conventionally produced by catcher molecules dissolved in a liquid being applied (spotted) onto a carrier substrate and subsequently being immobilized, for example with the liquid drying up. In this case, the catcher molecules can be constructed piece by piece on the carrier substrate (on-chip synthesis) or can be printed, after having been fully synthesized, onto the carrier substrate. In this case, the catcher molecules combine with the surface of the carrier substrate or are adsorbed at the surface of the carrier substrate. A construction of this type is also referred to, inter alia, as a biochip.

The sample to be examined is subsequently applied to the catcher molecule spots, wherein the molecular groups to be detected bind to the catcher molecule spots and the remaining sample constituents are rinsed away. The result can subsequently be read out by means of detection methods, such as fluorescence methods.

Microarrays conventionally comprise a carrier substrate composed of glass or a plastic and are used as disposable articles. However, catcher molecules cannot bind directly to an untreated glass or plastic surface and would be rinsed away in the subsequent steps. Therefore, glass or plastic carrier substrates conventionally comprise a whole-area surface functionalization for immobilizing catcher molecules.

A porous microfluidic structure is known from DE 10 2007 036 906 A1.

### DISCLOSURE OF THE INVENTION

The present invention relates to a microarray, comprising a carrier substrate and a multiplicity of immobilization particles for immobilizing, in particular biochemical, catcher molecules, wherein the immobilization particles each comprise a first sub-section bonded to the carrier substrate and a second sub-section, which is exposed.

By way of example, the immobilization particles can form an ionic bond or covalent bond with catcher molecules or can adsorb the latter, for example by means of hydrogen bridge bonds and/or hydrophobic interactions.

The microarray according to the invention has the advantage that a complex and cost-intensive surface functionalization of the carrier substrate can be dispensed with.

Furthermore, by dispensing with a surface functionalization of the carrier substrate, it is possible to achieve the effect that catcher molecules and sample molecules are not immobilized on the surface of the carrier substrate, but rather only locally on the immobilization particles. Since the catcher molecules cannot adhere on the carrier substrate outside the immobilization particles and are immobilized only on the immobilization particles, the spot size is substantially defined by the size and manner of attachment of the immobilization particles. This has the advantage that, with generous spotting and subsequent washing of the microarray, it is also possible to use a spotting device having a low spotting accuracy. Moreover, in this way it is possible to reduce the background noise when reading the microarray by means of detection methods, such as fluorescence methods.

Moreover, the spot surface area is increased by the immobilization particles and it is possible to bind more molecules per area. Since, by way of example, the fluorescence signal when reading microarrays is dependent on the spot surface area, in this way it is possible to achieve a higher sensitivity when reading the microarray.

In the context of one preferred embodiment of the microarray according to the invention, the first sub-section is bound, in particular impressed, into the carrier substrate. In particular, the first sub-section can in this case be bonded to the carrier substrate in a positively locking manner or be bound into the carrier substrate in a positively locking manner.

In the context of a further preferred embodiment of the microarray according to the invention, the second sub-section projects from the carrier substrate. As a result of the projection or elevation of the immobilization particles, the spots are also raised with respect to the carrier substrate surface. This has the advantage that the signal plane in which, by way of example, the fluorescence is measured is spaced apart from the surface of the carrier substrate, which leads to a reduction of the background signal, an improvement in the ratio between the actual signal and the background noise (signal to noise ratio), and thus to a further increase in the sensitivity.

In the context of one configuration of a further preferred embodiment of the microarray according to the invention, the carrier substrate is formed from a plastic, in particular a thermoplastic, wherein the immobilization particles each comprise a particle core composed of glass or plastic, for example a thermoplastic. In the context of another configuration of this further preferred embodiment of the microarray according to the invention, the carrier substrate is formed from glass, wherein the immobilization particles each comprise a particle core composed of plastic, for example a thermoplastic. By way of example, the carrier substrate or the particle cores of the immobilization particles can in this case be formed from a polycarbonate (PC), a cycloolefin polymer (COP) or a cycloolefin copolymer (COC). In this way, an adhesive can advantageously be dispensed with when bonding the immobilization particles to the carrier substrate.

In the context of one configuration of a further preferred embodiment of the microarray according to the invention, the surface of the particle cores is functionalized for immobilizing catcher molecules. In the context of another configuration of this embodiment of the microarray according to the invention, the particle cores each comprise an immobilization coating for immobilizing catcher molecules. By way of example, the immobilization particles can be glass beads which are functionalized by reaction with an organosilane, for example an amino(alkyl)silane, an epoxysilane or an aldehydesilane, or which comprise a functionalized coating, for example an aminosilane, epoxysilane, aldehydesilane or nitrocellulose coating. These can form ionic, covalent or non-covalent bonds with nucleic acids, peptides, cells and/or small molecules. In this case, a non-covalent bond is understood to mean adsorption, in particular a bond by hydrogen bridge bonds and/or hydrophobic interactions. The surface area of the glass beads can be increased by means of an etching method carried out prior to functionalization or coating.

The immobilization particles can be embodied in spherical fashion, fibrous fashion or in gravel-like fashion. By way of example, the immobilization particles can have an average particle size in a range of ≧20 μm to ≦500 μm or of ≧100 μm to ≦500 μm.

In the context of a further preferred embodiment of the microarray according to the invention, catcher molecules are immobilized on the second sub-section. In this case, different catcher molecules can be immobilized on different immobilization particles.

The present invention furthermore relates to a device for producing a microarray, according to the invention, comprising a carrier substrate holder for holding a carrier substrate, and at least one movable pin, in particular a plurality of movable pins, for receiving at least one immobilization particle and for transporting the immobilization particle to a carrier substrate held by the carrier substrate holder.

In this case, the at least one pin can have a planar receptacle surface for receiving one or a plurality of immobilization particles.

In the context of one preferred embodiment of the device according to the invention, the at least one pin has a receptacle surface having at least one depression, in particular a plurality of depressions, for receiving immobilization particles. In this case, the at least one depression can be designed for receiving one immobilization particle or for receiving a plurality of immobilization particles. Preferably, the at least one depression is designed for receiving one immobilization particle. In this case, the form and size of the at least one depression can correspond approximately to the form and size of half an immobilization particle. In this way, it can be ensured that in each depression only one immobilization particle is received, transported to the carrier substrate and bonded to the latter.

In particular, the at least one pin can have a receptacle surface having two or more depressions spaced apart from one another. In this way, by means of one pin, a plurality of immobilization particles arranged at a defined distance from one another can be simultaneously received, transported and bonded to the carrier substrate.

In the context of a further preferred embodiment of the device according to the invention, the pin, in particular the receptacle surface of the pin, and/or the carrier substrate holder are/is heatable. In this way, immobilization particles and carrier substrate can be thermoplastically bonded, in so far as at least one of the elements to be bonded is based on a thermoplastic. Preferably, in this case the at least one pin and/or the carrier substrate holder are/is heatable to a temperature which is sufficiently above the glass transition temperature (T_{g}) of the thermoplastic of the immobilization particle and/or the carrier substrate. By way of example, the at least one pin can be heatable to a temperature which is at least 20 K, for example 20 K to 40 K, above the glass transition temperature (T_{g}) of the thermoplastic of the immobilization particle and/or of the carrier substrate. By way of example, the glass transition temperature (T_{g}) is approximately 140° C. in the case of a polycarbonate and approximately 145° C. in the case of a cycloolefin copolymer.

Preferably, the carrier substrate holder is positioned or positionable above (in relation to gravitation) the at least one pin. In this case, the at least one pin is preferably movable up and down (in relation to gravitation), wherein the upper surface (in relation to gravitation) of the at least one pin is the receptacle surface.

In the context of a further preferred embodiment of the device according to the invention, the device furthermore comprises an immobilization particle replenishing region for receiving a multiplicity of immobilization particles, said immobilization particle replenishing region having a base having a base surface. In this case, the at least one pin is preferably movable through the base from a first position, in which the receptacle surface of the pin is positioned below the base surface, for example below the base surface and within the base, into a second position, in which the receptacle surface of the pin is positioned above the base surface, in particular above the base surface and adjacent to a carrier substrate held above the immobilization particle replenishing region by the carrier substrate holder. In this way, in the first position, immobilization particles from the immobilization particle replenishing region can fall onto the receptacle surface of the pin and, in the second position, be brought into contact with the carrier substrate. Preferably, the depression-free regions of the receptacle surface of the at least one pin bear against the carrier substrate in the second position. In this way, the first sub-section of the immobilization particles can be bound, in particular impressed, into the carrier substrate. In this case, the binding depth, in particular the impressing depth, of the immobilization particles in the carrier substrate or the height by which the immobilization particles project from the carrier substrate can be set by the depth of the depression(s) of the at least one pin.

Furthermore, the device can comprise an immobilization particle reservoir. By means of this immobilization particle reservoir, further immobilization particles can be fed to the immobilization particle replenishing region. If appropriate, the immobilization particle replenishing region and/or the immobilization particle reservoir can the also be heatable.

The present invention furthermore relates to a method for producing a microarray, in particular a microarray according to the invention, using a device according to the invention, comprising the following method steps:
a) receiving at least one immobilization particle by means of the at least one movable pin,
b) transporting the at least one immobilization particle to a carrier substrate held by the carrier substrate holder, and
c) bonding the at least one immobilization particle to the carrier substrate.

The use of the device according to the invention in the method according to the invention makes it possible for immobilization particles to be positioned precisely, for example in a microarray chamber, and thus to be defined for individual spots.

Method steps a) to c) can be carried out simultaneously by a multiplicity of movable pins. However, it is likewise possible to repeat method steps a) to c)—with a change in the position of the carrier substrate holder and thus of the carrier substrate to be equipped—multiply with one or a plurality of movable pins.

By way of example, bonding the at least one immobilization particle to the carrier substrate in method step c) can be effected in such a way that the at least one immobilization particle comprises a first sub-section bonded, in particular in a positively locking manner, to the carrier substrate and a second sub-section, which is exposed and in particular projects from the carrier substrate.

In the context of one preferred embodiment of the method according to the invention, bonding the at least one immobilization particle to the carrier substrate in method step c) is effected in such a way that the at least one immobilization particle comprises a first sub-section bonded/impressed, for example in a positively locking manner, into the carrier substrate and a second sub-section projecting from the carrier substrate.

Bonding can be effected, if appropriate, by adhesive bonding. In the case of bonding by adhesive bonding, however, the compatibility of the adhesive with the probe materials, the analysis samples to be processed, etc. should be taken into account.

In order to avoid this, in the context of a further preferred embodiment of the method according to the invention, bonding in method step c) is effected by impressing the at least one immobilization particle into the carrier substrate or a deformable precursor of the carrier substrate. As a result of the impressing, a bead can arise around the immobilization particles. Impressing immobilization particles has the advantage that the immobilization particles project from the carrier substrate by the same height—independently of the particle diameter. As a result, a defined signal plane can be ensured for reading the microarray, which is of crucial importance particularly in the case of fluorescent read-out methods.

In the context of a further preferred embodiment of the method according to invention, adhesive bonding is avoided by virtue of the fact that bonding in method step c) is effected by thermoplastic bonding of the at least one immobilization particle to the carrier substrate.

By way of example, it is possible to use immobilization particles comprising a particle core composed of a thermoplastic and/or a carrier material composed of a thermoplastic. In this case, only the carrier material, only the at least one immobilization particle or both the carrier material and the at least one immobilization particle composed of a thermoplastic can be thermoplastically deformed. By way of example, an immobilization particle comprising a particle core composed of glass can be impressed into a carrier substrate composed of plastic. Alternatively, an immobilization particle comprising a particle core composed of a thermoplastic can be bonded to a carrier substrate composed of glass with thermoplastic deformation of the particle core. Alternatively, an immobilization particle comprising a particle core composed of a thermoplastic can be bonded to a carrier substrate composed of a thermoplastic with thermoplastic deformation of the particle core and/or of the carrier substrate.

The at least one pin and/or the carrier substrate holder are/is in this case preferably heated to a temperature which is (sufficiently) above the glass transition temperature (T_{g}) of the thermoplastic of the carrier substrate and/or of the at least one immobilization particle. By way of example, the at least one pin and/or the carrier substrate holder can be heated to a temperature which is at least 20 K, for example 20 K to 40 K, above the glass transition temperature (T_{g}) of the thermoplastic of the immobilization particle and/or of the carrier substrate.

In the context of a further preferred embodiment of the method according to the invention, the method furthermore comprises, in particular after the last method step c), the following method step: d) applying, in particular applying at points (spotting), catcher molecules on the immobilization particles. Since the complete surface of the carrier substrate is not surface-modified by the method according to the invention, catcher molecules are immobilized substantially only at the immobilization particles. This can firstly advantageously result in a reduction in the background noise.

Secondly, catcher molecules can be applied in such a way that an amount of catcher molecules or an amount of a solution of catcher molecules is applied which is larger than the amount necessary for wetting the, in particular exposed, immobilization particle surface. If appropriate, catcher molecules situated on the carrier substrate surface alongside the immobilization particles can be removed from the carrier substrate surface by a method step which, in particular, follows method step d), namely the following method step: e) washing the carrier substrate, in particular the carrier substrate surface, or the microarray, in particular the microarray surface having immobilization particles. This has the advantage that spotting devices having a low spotting accuracy can be used and spots having a defined spot size, in particular a spot size defined by the size and manner of attachment of the immobilization particles, can nevertheless be achieved.

Furthermore, the present invention relates to microarrays produced by a method according to the invention.

The present invention furthermore relates to a microfluidic system, in particular a lab-on-a-chip device, for example for medical applications, for example molecular diagnostics, which comprises a microarray according to the invention.

### DRAWINGS

Further advantages and advantageous configurations of the subjects according to the invention are illustrated by the drawings and explained in the following description. In this case, it should be taken into consideration that the drawings are merely descriptive in character and are not intended to restrict the invention in any form. In the figures:

FIG. 1a shows a schematic cross section through an embodiment of a microarray according to the invention;

FIG. 1b shows a schematic cross section through the microarray shown in FIG. 1a with catcher molecules immobilized on the immobilization particles;

FIG. 2a shows a schematic cross section through an embodiment of a device according to the invention during a first method step a) of the method according to the invention;

FIG. 2b shows the device shown in FIG. 2a during a first method step c);

FIG. 2c shows the device shown in FIGS. 2a and 2b during a second method step a);

FIG. 3a shows a schematic cross section through a first embodiment of a movable pin of a device according to the invention;

FIG. 3b shows a schematic cross section through a second embodiment of a movable pin of a device according to the invention; and

FIG. 3c shows a schematic cross section through a third embodiment of a movable pin of a device according to the invention.

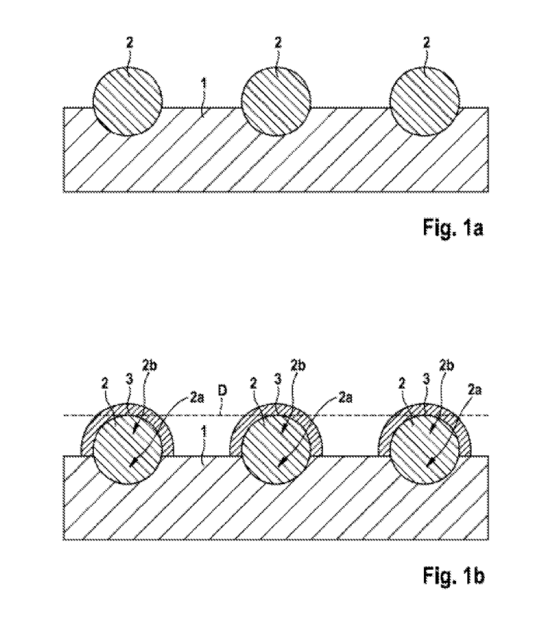

FIG. 1a shows that the microarray comprises a carrier substrate 1 and a multiplicity of immobilization particles 2 for immobilizing catcher molecules, wherein the immobilization particles 2 each comprise a first sub-section 2a bonded to the carrier substrate 1 and a second sub-section 2b, which is exposed. FIG. 1a illustrates that the second, exposed sub-section 2b is in this case accessible from outside the carrier substrate 1. In this case, FIG. 1a illustrates that the immobilization particles 2 in this way make available local, potential binding regions for catcher molecules to be immobilized.

FIG. 1a furthermore shows that, in this case, the first sub-section 2a is respectively bound or impressed into the carrier substrate 1 in a positively locking manner, wherein the second sub-section 2b projects from the carrier substrate 1. As shown in FIG. 1a, the immobilization particles 2 can be bound into the carrier substrate 1 in such a way that one hemisphere of a spherical immobilization particle is bound into the carrier substrate 1, the other hemisphere of the same immobilization particle 2 projecting from the carrier substrate 1. It can thus be ensured that the signal plane D in which, by way of example, the fluorescence is measured is spaced apart from the surface of the carrier substrate 1.

For this purpose, the carrier substrate 1 is preferably formed from a plastic. In this case, the immobilization particles 2 preferably each comprise a particle core composed of glass which has an immobilization coating for immobilizing catcher molecules or whose surface is functionalized for immobilizing catcher molecules.

FIG. 1b shows the microarray from FIG. 1a after the application, in particular spotting, of catcher molecules 3 on the immobilization particles 2 and illustrates that catcher molecules 3 are immobilized on the second sub-section 2b.

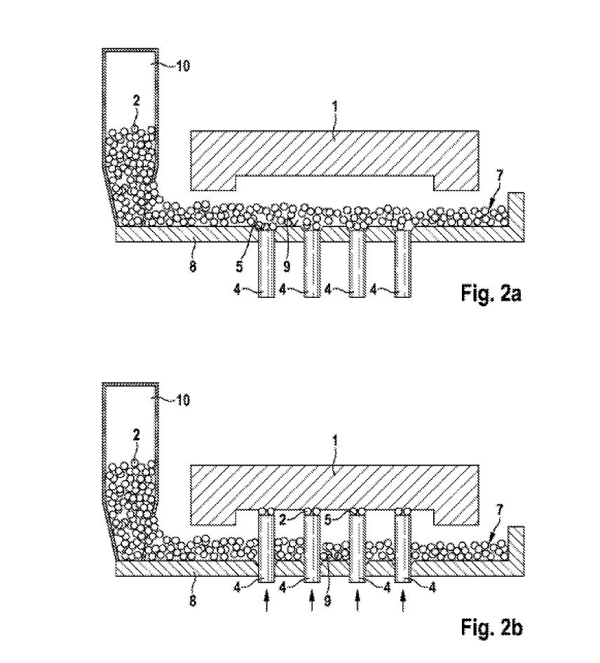

FIGS. 2a to 2c show an embodiment of a device according to the invention for producing a microarray according to the invention, which comprises a carrier substrate holder (not illustrated) for holding a carrier substrate 1 and a multiplicity of movable pins 4, in particular four movable pins 4, having planar receptacle surfaces 5 for receiving and for transporting immobilization particles 2 to a carrier substrate 1 held by the carrier substrate holder 4. For equipping a carrier substrate 1 composed of a thermoplastic, the pins 4 are preferably heatable. For equipping a deformable precursor of a carrier substrate 1, the pins 4 can be embodied in unheated fashion. Furthermore, the device comprises an immobilization particle replenishing region 7 for receiving a multiplicity of immobilization particles 2. FIGS. 2a to 2c show that the immobilization particle replenishing region 7 has a base 8 having a base surface 9, wherein the pins 4 are movable through the base 8 from a first position, in which the receptacle surfaces 5 of the pins 4 is positioned below the base surface 9, into a second position, in which the receptacle surfaces 5 of the pins 4 is positioned above the base surface 9 and adjacent to the carrier substrate 1 held above the immobilization particle replenishing region 7 by the carrier substrate holder.

FIGS. 2a to 2c furthermore illustrate an embodiment of the production method according to the invention. FIG. 2a shows that, in method step a), in which the pins 4 are positioned in the first position, immobilization particles 2 are received on the receptacle surfaces 5 of the pins 4. In this case, the immobilization particles 2 slip, in particular, from the immobilization particle replenishing region 7 onto the receptacle surfaces 5—positioned more deeply—of the pins 4. In other words, the pins 4 are offset downward relative to the surrounding immobilization particle replenishing region 7 in the first position, such that new immobilization particles fall in upon the retraction of the pins 4. Depending on the size and form of the pins 4 and immobilization particles 2, in this case individual immobilization particles 2 or an accumulation of immobilization particles can be received, transported and bonded to the carrier substrate 1. In this case, a glass bead reservoir provides for continuous feeding of immobilization particles 2.

FIG. 2b illustrates that the pins 4 are moved upward into the second position. In this case, the received immobilization particles 2 are transported to the carrier substrate and bonded to the latter by the immobilization particles 2 being impressed into the carrier substrate 1 or a deformable precursor of the carrier substrate 1. FIG. 2b illustrates that bonding is effected in this case in such a way that the immobilization particles 2 comprise a first sub-section 2a impressed into the carrier substrate 1 in a positive locking manner and a second sub-section 2b projecting from the carrier substrate 1.

FIG. 2c shows that the pins are subsequently moved downward again into the first position, in which new immobilization particles 2 slip or fall onto the receptacle surfaces 5 of the pins 4.

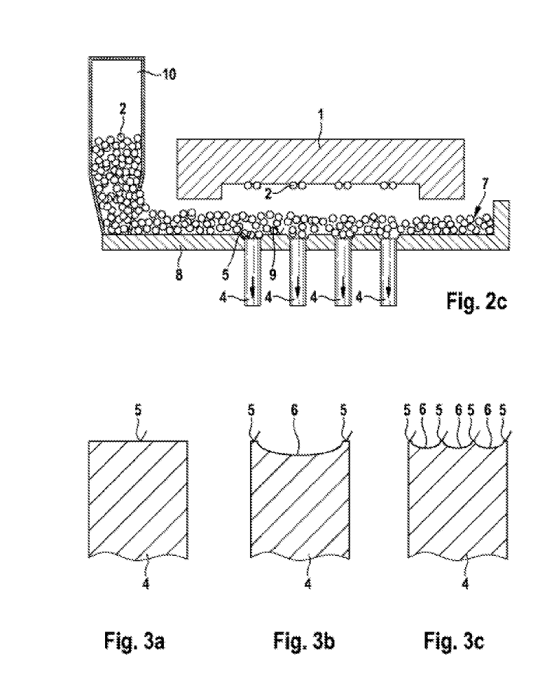

FIGS. 3a to 3c show a first, second and third embodiment of a movable pin 5 of a device according to the invention. In the context of the first embodiment shown in FIG. 3a, the pin 5 has a planar receptacle surface 5. In the context of the second embodiment shown in FIG. 3b, the pin 4 has a receptacle surface 5 having one depression 6 for receiving immobilization particles 2. In the context of the third embodiment shown in FIG. 3c, the pin 4 has a receptacle surface 5 having three depressions 6 spaced apart from one another and serving for receiving one immobilization particle 2 in each case. FIG. 3c shows that in this case the form and size of the depressions correspond approximately to the form and size of half an immobilization particle 2. In this way, it can be ensured that in each depression only one immobilization particle 2 is received, transported to the carrier substrate 1 and bonded to the latter, the immobilization particles 2 being positioned at a defined distance from one another.

1. A microarray, comprising:
a carrier substrate; and
a plurality of immobilization particles configured to immobilize catcher molecules of a plurality of catch molecules, each immobilization particle of the plurality of immobilization particles including a first sub-section bonded to the carrier substrate and a second sub-section,
wherein the second sub-section is exposed.

2. The microarray as claimed in claim 1, wherein the first sub-section is bound into the carrier substrate.

3. The microarray as claimed in claim 1, wherein the second sub-section projects from the carrier substrate.

4. The microarray as claimed in claim 1, wherein:
the carrier substrate is formed from a plastic and each immobilization particle of the plurality of immobilization particles includes a particle core composed of glass or plastic, or
the carrier substrate is formed from glass and each immobilization particle of the plurality of immobilization particles includes a particle core comprised of plastic.

5. The microarray as claimed in claim 4, wherein:
the surface of the particle cores is functionalized for immobilizing catcher molecules of the plurality of catcher molecules, and/or
the particle cores each comprise an immobilization coating for immobilizing catcher molecules of the plurality of catcher molecules.

6. The microarray as claimed in claim 1, wherein catcher molecules of the plurality of catcher molecules are immobilized on the second sub-section.

7. A device for producing a microarray, having a carrier substrate and a plurality of immobilization particles, comprising:
a carrier substrate holder for holding the carrier substrate, and
at least one movable pin for receiving at least one immobilization particle of the plurality of immobilization particles and for transporting the at least one immobilization particle to the carrier substrate held by the carrier substrate holder,
wherein each immobilization particle of the plurality of immobilization particles includes a first sub-section bonded to the carrier substrate and a second sub-section,
wherein the plurality of immobilization particles is configured to immobilize a plurality of catcher molecules, and
wherein the second sub-section is exposed.

8. The device as claimed in claim 7, wherein the at least one pin has a receptacle surface having at least one depression for receiving immobilization particles of the plurality of immobilization particles.

9. The device as claimed in claim 7, wherein the pin and/or the carrier substrate holder are/is heatable.

10. The device as claimed in claim 7, further comprising:
an immobilization particle replenishing region configured to receive a multiplicity of immobilization particles of the plurality of immobilization particles,
wherein the immobilization particle replenishing region comprises a base having a base surface, and
wherein the at least one pin is movable through the base from a first position, in which the receptacle surface of the pin is positioned below the base surface, into a second position, in which the receptacle surface of the pin is positioned above the base surface and adjacent to the carrier substrate held above the immobilization particle replenishing region by the carrier substrate holder.

11. A method for producing a microarray, comprising:
receiving at least one immobilization particle of a plurality of immobilization particles by means of at least one movable pin;
transporting the at least one immobilization particle to a carrier substrate held by a carrier substrate holder; and
bonding the at least one immobilization particle to the carrier substrate,
wherein immobilization particles of the plurality of immobilization particles are configured to immobilize catcher molecules of a plurality of catcher molecules.

12. The method as claimed in claim 11, wherein the bonding is effected in such a way that the at least one immobilization particle comprises a first sub-section bound into the carrier substrate and a second sub-section projecting from the carrier substrate.

13. The method as claimed in claim 11, wherein the bonding is effected by impressing the at least one immobilization particle into the carrier substrate or a deformable precursor of the carrier substrate.

14. The method as claimed in claim 11, wherein the bonding is effected by thermoplastic bonding of the at least one immobilization particle to the carrier substrate.

15. The method as claimed in claim 11, further comprising:
applying catcher molecules of the plurality of catcher molecules on immobilization particles of the plurality of immobilization particles.
